(19) United States
(12) Patent Application Publication
(10) Pub. No.: US 2021/0162797 A1
(43) Pub. Date: Jun. 3, 2021

(54) WRITING INSTRUMENT AND METHOD FOR MANUFACTURING WRITING INSTRUMENT

(71) Applicant: Kotobuki & Co., Ltd., Kawagoe-shi (JP)

(72) Inventors: Hidehei Kageyama, Kawagoe-shi (JP); Takeshi Wakayama, Kawagoe-shi (JP)

(73) Assignee: KOTOBUKI & CO., LTD.

(21) Appl. No.: 17/169,771

(22) Filed: Feb. 8, 2021

Related U.S. Application Data
(62) Division of application No. 16/412,068, filed on May 14, 2019.

(51) Int. Cl. B43K 21/16; B43K 21/00; B43K 29/02; B43K 21/22

(52) U.S. Cl. CPC B43K 21/16; B43K 21/22; B43K 29/02; B43K 21/006

(57) ABSTRACT

A method for manufacturing a writing instrument includes inject molding a cushion spring of the writing instrument to form the cushion spring as one piece, and axially pushing out the cushion spring from a molding die set. The cushion spring elastically supports a tip of the writing instrument in an axial direction to a barrel of the writing instrument. The forming of the cushion spring includes forming a plurality of apertures in the cushion spring, one of the apertures being relatively arranged with another one of the apertures by rotations of angles at 90 degrees about the axial direction on an outer peripheral surface thereof, and forming a plurality of displacement regulating protrusions, one of the protrusions being relatively arranged with another one of the protrusions by rotations of angles at 90 degrees about the axial direction.

The present application is a Divisional Application of U.S. patent application Ser. No. 16/412,068, filed on May 14, 2019, the entire content of which is incorporated herein by reference.

The embodiments discussed herein relate to writing instruments including mechanical pencils.

### BACKGROUND

A mechanical pencil disclosed in Patent Document 1 includes a barrel, a chuck mechanism disposed in the barrel that grips and advances forward a pencil lead, a primary cushion spring set with a specified installation load that elastically supports the chuck mechanism in the axial direction to the barrel, and a secondary cushion spring that elastically supports the chuck mechanism in the axial direction to the barrel, wherein the secondary cushion spring is configured to be elastically deformable due to the specified installation load of the primary cushion spring. The mechanical pencil may include a supporting member that supports the prescribed installation load of the primary cushion spring in the axial direction. According to the above disclosure, the secondary cushion spring may be made by plastic-injection molding, and absorbs a writing load below the installation load of the primary cushion spring.

[Patent Document 1] PCT International Patent Application Publication WO2018/164208. For example, refer to paragraphs [0006] and [0013].

However, a cushion spring made by plastic-injection molding is highly vulnerable to undesirable permanent plastic deformations upon compression beyond its elastically compressible length at which point the elasticity of the spring is lost. For example, the cushion spring is loaded to such a compression load, when removing cushion springs from the molding die sets after being formed in injection-molding machines as well as during product assembly or when the assembled product is being used for writing. For this reason, preventative measures to eliminate the risks of such a cushion spring from being compressed beyond its elastically compressible length were desired.

### SUMMARY

In embodiments according to one exemplary aspect of the invention, a writing instrument includes a barrel, a tip, and a cushion spring that elastically supports the tip in the axial direction to the barrel, wherein the cushion spring is formed as a single piece by injection molding. The cushion spring includes an aperture on its outer peripheral surface and a displacement regulating protrusion that protrudes and extends into the aperture along the axial direction. The protrusion prevents the cushion spring from compression beyond a prescribed length.

In other exemplary embodiments according to another aspect of the invention, a method for manufacturing the writing instrument includes axially pushing out the cushion spring from a molding die set.

In other exemplary embodiments according to another aspect of the invention, a method for manufacturing the writing instrument includes axially pushing insert the cushion spring into the barrel.

In the above-mentioned embodiments, a writing instrument, eliminating the risks of the cushion spring from being compressed beyond its elastically compressible length, is provided.

The present invention will become more fully understood from the detailed description given hereinbelow. The other applicable fields will become apparent with reference to the detailed description given hereinbelow. However, the detailed description and the specific embodiment are illustrated of desired embodiments of the present invention and are described only for the purpose of explanation. Various changes and modifications will be apparent to those ordinary skilled in the art on the basis of the detailed description. The applicant has no intention to give to public any disclosed embodiments. Among the disclosed changes and modifications, those which may not literally fall within the scope of the present claims constitute, therefore, a part of the present invention in the sense of doctrine of equivalents.

### BRIEF DESCRIPTION OF DRAWINGS

The exemplary aspects of the invention will be better understood from the following detailed description of the exemplary embodiments of the invention with reference to the drawings in which:

FIG. 1 is a cross-sectional view illustrating a writing instrument according to an exemplary embodiment; and

FIG. 2 illustrates a perspective view of a cushion spring of the writing instrument of FIG. 1.

### DESCRIPTION OF EXEMPLARY EMBODIMENTS

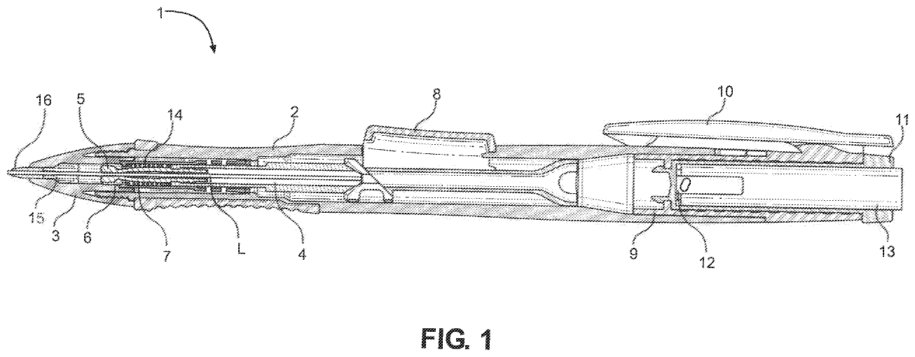

Referring to FIG. 1, a mechanical pencil 1 as an exemplary embodiment of a writing instrument includes a barrel body 2 formed in an approximately tubular shape and a nose cone 3 formed in an approximately conical outer shape with an inner tube forming a double-tube structure. The nose cone 3 is detachably attached to the front part of the barrel body 2.

A pencil lead tube 4 is disposed inside the barrel body 2 to be movable in the axial direction. The pencil lead tube 4 houses the pencil lead L inside. A chuck 5, as a tip of the writing instrument, is disposed in the frontal part of the pencil lead tube 4. The chuck 5 is formed to grip the pencil lead L with its frontal part including chuck strips formed in a plurality of equally divided parts in the circumferential direction, each of which are elastically deformable in the radial direction to chuck and release the pencil lead L. The chuck 5 includes a base part at its rear end where it is inserted and fixed to the pencil lead tube 4, a beam-shaped part where it extends forward from the base part and a bulge part that is formed at the front tip end of the beam-shaped part.

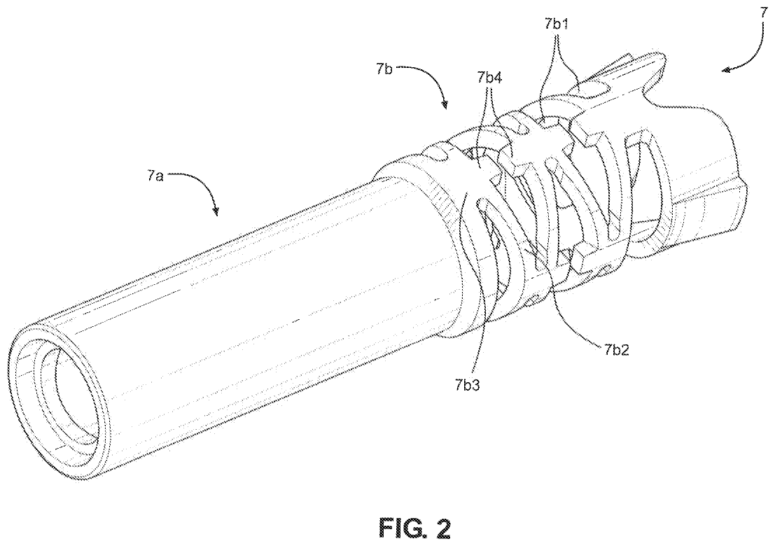

A chuck ring 6 is fitted to the outer periphery of the bulge part of the chuck 5 and configured to be detachable rearwards from the chuck 5. A cushion spring 7, which is formed in an approximately tubular shape with an annular wall 7a1 (refer to FIG. 2) in the front part thereof, abuts the rear end of the chuck ring 6 and is disposed to cover the area from the beam-shaped part of the chuck 5 to the frontal part of the pencil lead tube 4 from the radially outward direction. The cushion spring 7 is formed as one piece (e.g., having a unitary construction, integrally-formed, etc.) by injection molding and includes a sleeve part 7a and a spring part 7b, as illustrated in FIG. 2.

Referring to FIG. 1 and FIG. 2, the sleeve part 7a, as the frontal part of the cushion spring 7, is inserted inside the nose cone 3 along the inner peripheral surface of the inner tube of the nose cone 3. The spring part 7b is formed at the rear part of cushion spring 7 in an approximately tubular shape with elongated apertures (e.g., as openings) 7b1 and displacement regulators (e.g., as displacement regulating protrusions) 7b4 as described specifically below. The spring part 7b functions as a spring. The technical design and the function of the spring part 7b will be explained in detail later. An annular wall 7al is formed on the inner peripheral surface of sleeve 7a protruding inward in the radial direction.

A chuck unit, housed inside of the barrel body, is capable of gripping and advancing forward the pencil lead L. A chuck unit includes the chuck 5, the chuck ring 6, and the sleeve part 7a of the cushion spring 7. The chuck unit is elastically supported by the cushion spring 7, namely the spring part 7b of the cushion spring 7, such that it can recess backwards and absorb excess writing load that is applied along the axial direction to prevent the breakage of the pencil lead L or the chuck unit.

The cushion spring 7 is assembled with an arbitrary prescribed installation load, such that the spring part 7b of the cushion spring 7 is in an installed state of compression, disposed in between the step part formed on the inner peripheral surface of the inner tube of the nose cone 3 and the protruding part formed on the inner peripheral surface of the barrel body 2. The prescribed installation load may include zero.

The pencil lead L is advanced forward upon actuation of aside click button 8, which in turn advances the pencil lead tube 4 forward in the axial direction. An engagement part to be engaged with the actuated side click button 8 is formed on the outer peripheral wall of the pencil lead tube 4 to thrust forward the pencil lead tube 4. The engagement part is sloped such that the tip of the side click button 8 comes into contact upon actuation of the side click button 8.

The side click button 8 is inserted into an aperture formed on the barrel body 2, with the side click button 8 to be rotatably supported around the rear end edge of the aperture upon insertion. The supported part becomes the pivot for actuation motion of the side click button 8, as the side click button 8 switches back and forth between the states where side click button 8 is engaged or disengaged with the engagement part of the pencil lead tube 4.

The side click button 8 is formed with side skirts, whereas the front bottom tips of the side skirts are ready to be in contact with the sloped surface of the engagement part. The side click button 8 is pushed upwards in a free state, due to the rearward bias force on the pencil lead tube 4.

A tubular cap 9, that is formed with a clip 10, is arranged on the rear end part of the barrel body 2. By detaching the tubular cap 9, additional pencil leads can be reloaded into the pencil lead tube 4 through an orifice formed at the rear end of the barrel body 2. An eraser container tube 11 that can be rotated by users to dispense the eraser 13 rearward is assembled into the inner cavity of the tubular cap 9. An eraser holder 12 is assembled together with the eraser container tube 11 to be movable in the axial direction by a screw mechanism rotated by the eraser container tube 11, and an eraser 13 is held by the eraser holder 12. A twist knob is formed on the rear end part of the eraser container tube 11 which can be twisted and rotated in the circumferential direction so that the eraser 13 may either be extended or retracted.

Next, actuation of the mechanism to advance the pencil lead L is described. Upon the actuation of a side click button 8 of chuck 5, the tips of the skirts of the side click button 8 of chuck 5 presses down on the sloped surface of the engagement part of the pencil lead tube 4, and therefore the pencil lead tube 4 moves forward against the rearward bias force of the chuck spring 14, and the pencil lead L that is gripped by the chuck 5 disposed at the front tip of the pencil lead tube 4 is advanced forward and outward along the axial direction from the tip of the nose cone 3.

A chuck spring 14 is disposed in between the outer peripheral surface of the beam-shaped part of the chuck 5 and the inner peripheral surface of the sleeve part 7a of the cushion spring 7 in the radial direction. The chuck spring 14 is disposed such that its frontal part is in contact with the mar surface of annular wall 7a1 of the cushion spring 7a with its rear part in contact with the frontal end surface of the pencil lead tube 4 in the axial direction. Therefore, chuck spring 14 is disposed in between the cushion spring 7 and the pencil lead tube 4, compressed toward the axial direction to the barrel. Because the pencil lead tube 4 and the chuck 5 are biased rearward with respect to the sleeve part 7a of the cushion spring 7, due to a bias force of the chuck spring 14, the chuck ring 6, which is fitted to the chuck 5, is also biased rearwards with respect to the sleeve part 7a. Therefore, the rear end surface of the chuck ring 6 and the front surface of the annular wall 7a1 of sleeve part 7a will be in contact with each other.

An outer annular spot facing is formed on the inner peripheral surface of the inner tube of the nose cone 3 such that the outer annular spot facing opposes the frontal end surface of the sleeve part 7a of the cushion spring 7. The frontal end surface of the sleeve part 7a of the cushion spring 7 is brought into contact with the outer annular spot facing in a state of being biased forward by the spring part 7b of the cushion spring 7.

An inner annular spot facing is formed on the inner peripheral surface of the inner tube of the nose cone 3, which can come into contact with the frontal end surface of the chuck ring 6 when the inner annular spot facing advances forward. When the frontal end surface of the chuck ring 6 comes into contact with the inner annular spot facing of the nose cone 3, the pencil lead L is released from the grip of the chuck 5 as the chuck ring 6 is released rearward from the chuck 5.

A pencil lead holder 15 is arranged to be movable along the axial direction in the proximity of the front side of frontal end surface of chuck 5. A plurality of slits that extend in the longitudinal direction are formed on the pencil lead holder 15. A hole is formed in the center of pencil lead holder 15 through which the pencil lead L is inserted in the axial direction. In the fontal end part of the central hole of the pencil lead holder 15, a holding part is formed which grips the pencil lead L inwards along the radial direction. In the frontal part of the pencil lead holder 15, a tip piece 16 formed in an approximately thin tubular shape is arranged which is movable along the axial direction and supports the pencil lead L from the radially outward direction, while also having an outer peripheral surface to slide in the inner peripheral surface of the front opening of the nose cone 3. The pencil lead holder 15 is inserted into the tip piece 16 from the rear side and assembled together with the tip piece 16.

As illustrated in FIG. 2, the spring part 7b of the cushion spring 7 is formed by a plurality of coupled pairs of elongated apertures 7b1, each of which line up along the axial direction on the outer tubular wall, where the elongated apertures 7b1 that open up along the circumferential direction on the outer tubular wall are formed in coupled pairs that face each other about the axial direction. Adjacently coupled pairs of elongated apertures 7b1, in the axial direction, are relatively arranged with the other coupled pairs of elongated apertures 7b1 by rotations of angles at 90 degrees about the axial direction, circumferentially. Such an arrangement is advantageous as the length of the spring part 7b can be shortened in the axial direction, which in turn allows cushion spring 7 to be more compactly designed. In this exemplary embodiment, five coupled pairs of elongated apertures 7b1 are formed along the axial direction. A beam-shaped elastic part 7b2 is formed in between the adjacent pairs of elongated apertures 7b1 in the axial direction. Furthermore, a support member 7b3 is formed in between the adjacent pairs of elongated apertures 7b1 in the axial direction. The beam-shaped elastic part 7b2 is formed such that its thickness in the axial direction gradually decreases (e.g., tapered) from the support member 7b3 arranged in the frontal part (e.g., the base part) toward the adjacent support member 7b3 arranged in the rear part (e.g., the tip part) in the axial direction. Therefore, the spring part 7 generates a non-linear spring load with a preferred writing touch when the beam-shaped elastic parts 7b2 are bent toward the direction of compression of elongated apertures 7b1, when a writing load is applied along the axial direction.

The spring part 7b further includes a plurality of displacement regulators (e.g., displacement regulating protrusions) 7b4 that protrude from each support member 7b3 through the elongated apertures 7b1 toward the closest adjacent support member 7b3, forming a pair of hardpoints 73, along the axial direction. Displacement regulators 7b4, protruding through each elongated aperture 7b1, form a coupled pair of displacement regulators 7b4 that protrude toward each other between the structural hardpoints 7b3 along the axial direction. Furthermore, the displacement regulators 7b4 are relatively arranged with respect to each other upon rotations in the radial direction by 90 degrees about the axial direction. In this exemplary embodiment, three out of five coupled pairs of elongated apertures 7b1 are formed with a coupled pair of displacement regulators 7b4 that protrude toward each other along the axial direction, along and in the axial direction.

According to the exemplary configurations illustrated as the spring part 7b of the cushion spring 7, when the spring part 7b is compressed, the elongated apertures 7b1 are collapsed along the axial direction. The coupled pair of support members 7b4 that protrude toward each other along the axial direction through the elongated aperture 7b come in contact with each other, and the adjacent beam-shaped elastic parts 7b2 along the axial direction are prevented from coming into close contact with one another. Therefore, by forming displacement regulators 7b4, as protruding parts that extend along the axial direction from the spring part 7b, a loss of elasticity in the spring due to over-compression from cushion stroke operations can be prevented. Furthermore, this prevents the loss of elasticity in the spring due to over-compression even when removing cushion springs from the molding die sets after being formed in injection-molding machines (e.g., by a procedure of axially pushing out the cushion spring 7 from molding die sets), and also during product assembly (e.g., by a procedure of axially pushing insert the cushion spring 7 into the barrel 2). In such cases, the productivity of the manufacturing the writing instruments is preferably improved.

Moreover, in other exemplary embodiments, the pair of protrusions 7b4 may be modified into a couple of a protrusion and a flat surface or a recess. Furthermore, in other exemplary embodiments, the mechanical pencil 1 may be modified into a ball pen as a writing instrument with cushion spring supporting a tip of ball pen.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Exemplary embodiments of this invention are described herein, including the best mode known to the inventors for carrying out the invention. Variations of those exemplary embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The exemplary invention is not limited to the exemplary embodiments detailed above. The specific configuration of each portion can be modified within the range not departing from the purpose of the exemplary invention.

The descriptions of the various exemplary embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A method for manufacturing a writing instrument, the method including:
inject molding a cushion spring of the writing instrument to form the cushion spring as one piece; and
axially pushing out the cushion spring from a molding die set,
wherein the cushion spring elastically supports a tip of the writing instrument in an axial direction to a barrel of the writing instrument,
wherein the forming of the cushion spring includes:
forming a plurality of apertures in the cushion spring, one of the apertures being relatively arranged with another one of the apertures by rotations of angles at 90 degrees about the axial direction on an outer peripheral surface thereof; and
forming a plurality of displacement regulating protrusions, one of the protrusions being relatively arranged with another one of the protrusions by rotations of angles at 90 degrees about the axial direction, such that the one of the protrusions and the another one of the protrusions protrude and extend into the apertures along the axial direction, and
wherein the protrusions prevent the cushion spring from compression beyond a prescribed length.

2. The method according to claim 1, wherein the forming of the cushion spring further includes forming a coupled pair of the protrusions that protrude toward each other in the axial direction.

3. The method according to claim 1, wherein the forming of the cushion spring further includes forming a plurality of coupled pairs of the apertures that face each other about the axial direction, one adjacently coupled pairs of the apertures in the axial direction being relatively arranged with another adjacently coupled pairs of the apertures by rotations of angles at 90 degrees about the axial direction.

4. The method according to claim 1, wherein the forming of the cushion spring further includes:
forming a beam-shaped elastic part in between the adjacently coupled pairs of the apertures in the axial direction; and
forming a plurality of support members in between the adjacently coupled pairs of the apertures in the axial direction, and
wherein a thickness of the beam-shaped elastic part, in the axial direction, gradually decreases from one support member of the support members, arranged in a frontal part, towards another adjacent support member of the support members arranged in a rear part in the axial direction.

5. The method according to claim 1, wherein the forming of the cushion spring further includes forming a hardpoint in the axial direction, the hardpoint supporting the protrusion.

6. A method for manufacturing a writing instrument, the method including:
inject molding a cushion spring of the writing instrument to form the cushion spring as one piece; and
axially pushing the cushion spring into a barrel of the writing instrument,
wherein the cushion spring elastically supports a tip of the writing instrument in an axial direction to a barrel of the writing instrument,
wherein the forming of the cushion spring includes:
forming a plurality of apertures in the cushion spring, one of the apertures being relatively arranged with another one of the apertures by rotations of angles at 90 degrees about the axial direction on an outer peripheral surface thereof; and
forming a plurality of displacement regulating protrusions, one of the protrusions being relatively arranged with another one of the protrusions by rotations of angles at 90 degrees about the axial direction, such that the one of the protrusions and the another one of the protrusions protrude and extend into the apertures along the axial direction, and
wherein the protrusions prevent the cushion spring from compression beyond a prescribed length.

7. The method according to claim 6, wherein the forming of the cushion spring further includes forming a coupled pair of the protrusions that protrude toward each other in the axial direction.

8. The method according to claim 6, wherein the forming of the cushion spring further includes forming a plurality of coupled pairs of the apertures that face each other about the axial direction, one adjacently coupled pairs of the apertures in the axial direction being relatively arranged with another adjacently coupled pairs of the apertures by rotations of angles at 90 degrees about the axial direction.

9. The method according to claim 6, wherein the forming of the cushion spring further includes:
forming a beam-shaped elastic part in between the adjacently coupled pairs of the apertures in the axial direction; and
forming a plurality of support members in between the adjacently coupled pairs of the apertures in the axial direction, and
wherein a thickness of the beam-shaped elastic part, in the axial direction, gradually decreases from one support member of the support members, arranged in a frontal part, towards another adjacent support member of the support members arranged in a rear part in the axial direction.

10. The method according to claim 6, wherein the forming of the cushion spring further includes forming a hardpoint in the axial direction, the hardpoint supporting the protrusion.
